(19) United States
(12) Patent Application Publication
(10) Pub. No.: US 2010/0297983 A1
(43) Pub. Date: Nov. 25, 2010

(54) METHOD AND APPARATUS FOR ELECTRONIC CREDENTIAL SECURITY

(75) Inventors: Ville Aarni, Veikkola (FI); Miikka Sainio, Kerava (FI); Niklas Von Knorring, Helsinki (FI); Dmitry Kolesnikov, Vantaa (FI); Atte Lahtiranta, Bedford, MA (US)

Correspondence Address: DITTHAVONG MORI & STEINER, P.C., 918 Prince Street, Alexandria, VA, 22314, US

(73) Assignee: Nokia Corporation, Espoo (FI)

(21) Appl. No.: 12/468,799

(22) Filed: May 19, 2009

(51) Int. Cl. H04M 1/66; H04M 1/00

(52) U.S. Cl. 455/411; 455/558

(57) ABSTRACT

An approach is provided for improving the security of a mobile device by clearing credentials from the mobile device in response to a new user obtaining the device. Credentials associated with an identity module of a mobile device are stored. A new identity module associated with the mobile device or removal of the identity module is detected. The credentials from the mobile device are cleared based on the detection.

### BACKGROUND

Wireless (e.g., cellular) service providers and device manufacturers are continually challenged to deliver value and convenience to consumers by, for example, providing compelling network services, applications, and content, as well as user-friendly devices. Important differentiators in this industry are application and network services as well as the convenience and security of using the application and network services. In particular, credentials for these services can be stored on a device to facilitate consumer purchases. Traditionally, the management of credentials have been difficult because of the number of mobile users and frequency of change or upgrade of their mobile devices.

### SOME EXAMPLE EMBODIMENTS

Therefore, there is a need for an approach for improving the security of a mobile device by detecting and removing the credentials when a change of user is detected.

According to one embodiment, a method comprises storing credentials associated with an identity module of a mobile device. The method also comprises detecting a new identity module associated with the mobile device or removal of the identity module. The method further comprises clearing the credentials from the mobile device based on the detection.

According to another embodiment, an apparatus comprising at least one processor, and at least one memory including computer program code, the at least one memory and the computer program code configured to, with the at least one processor, cause the apparatus to store credentials associated with an identity module of a mobile device. The apparatus is also caused to detect a new identity module associated with the mobile device or removal of the identity module. The apparatus is further caused to clear the credentials from the mobile device based on the detection.

According to another embodiment, a computer-readable storage medium carrying one or more sequences of one or more instructions which, when executed by one or more processors, cause an apparatus to store credentials associated with an identity module of a mobile device. The apparatus is also caused to detect a new identity module associated with the mobile device or removal of the identity module. The apparatus is further caused to clear the credentials from the mobile device based on the detection.

According to another embodiment, an apparatus comprises means for storing credentials associated with an identity module of a mobile device. The apparatus also comprises means for detecting a new identity module associated with the mobile device or removal of the identity module. The apparatus further comprises means for clearing the credentials from the mobile device based on the detection.

According to one embodiment, a method comprises providing a service to a plurality of mobile devices. The method also comprises receiving a request from one of the mobile devices to retain credentials associated with an identity module of the one mobile device. The method further comprises storing the credentials of the one mobile device. The method also further comprises determining that the one mobile device has a new identity module associated with the one mobile device and deleting the stored credentials based on the determination.

According to another embodiment, an apparatus comprising at least one processor, and at least one memory including computer program code, the at least one memory and the computer program code configured to, with the at least one processor, cause the apparatus to provide a service to a plurality of mobile devices. The apparatus is also caused to receive a request from one of the mobile devices to retain credentials associated with an identity module of the one mobile device. The apparatus is further caused to store the credentials of the one mobile device. The apparatus is also further caused to determine that the one mobile device has a new identity module associated with the one mobile device and delete the stored credentials based on the determination.

According to another embodiment, a computer-readable storage medium carrying one or more sequences of one or more instructions which, when executed by one or more processors, cause an apparatus to provide a service to a plurality of mobile devices. The apparatus is also caused to receive a request from one of the mobile devices to retain credentials associated with an identity module of the one mobile device. The apparatus is further caused to store the credentials of the one mobile device. The apparatus is also further caused to determine that the one mobile device has a new identity module associated with the one mobile device and delete the stored credentials based on the determination.

According to another embodiment, an apparatus comprises means for providing a service to a plurality of mobile devices. The apparatus also comprises means for receiving a request from one of the mobile devices to retain credentials associated with an identity module of the one mobile device. The apparatus further comprises means for storing the credentials of the one mobile device. The apparatus also further comprises means for determining that the one mobile device has a new identity module associated with the one mobile device and deleting the stored credentials based on the determination.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of improving the security of a device by clearing user credentials stored on the device, according to one embodiment;

FIG. 2 is a diagram of the components of a user equipment according to one embodiment;

FIG. 3 is a diagram of the components of a service platform, according to one embodiment;

FIG. 4 is a flowchart of a process for clearing the credentials of a user equipment, according to one embodiment;

FIG. 5 is a flowchart of a process for client-side clearing of credentials of a user equipment, according to one embodiment;

FIG. 6 is a flowchart of a process for server-side clearing of credentials of a user equipment, according to one embodiment;

FIG. 7 and FIG. 8 are diagrams of user interfaces utilized in the processes of FIG. 4 to FIG. 6, according to various embodiments;

FIG. 9 is a diagram of hardware that can be used to implement an embodiment of the invention;

FIG. 10 is a diagram of a chip set that can be used to implement an embodiment of the invention; and

FIG. 11 is a diagram of a mobile station (e.g., handset) that can be used to implement an embodiment of the invention.

### DESCRIPTION OF PREFERRED EMBODIMENTS

A method and apparatus for electronic credential security are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although various embodiments are described with respect to mobile devices, it is contemplated that the approach described herein may be used with other devices and applications.

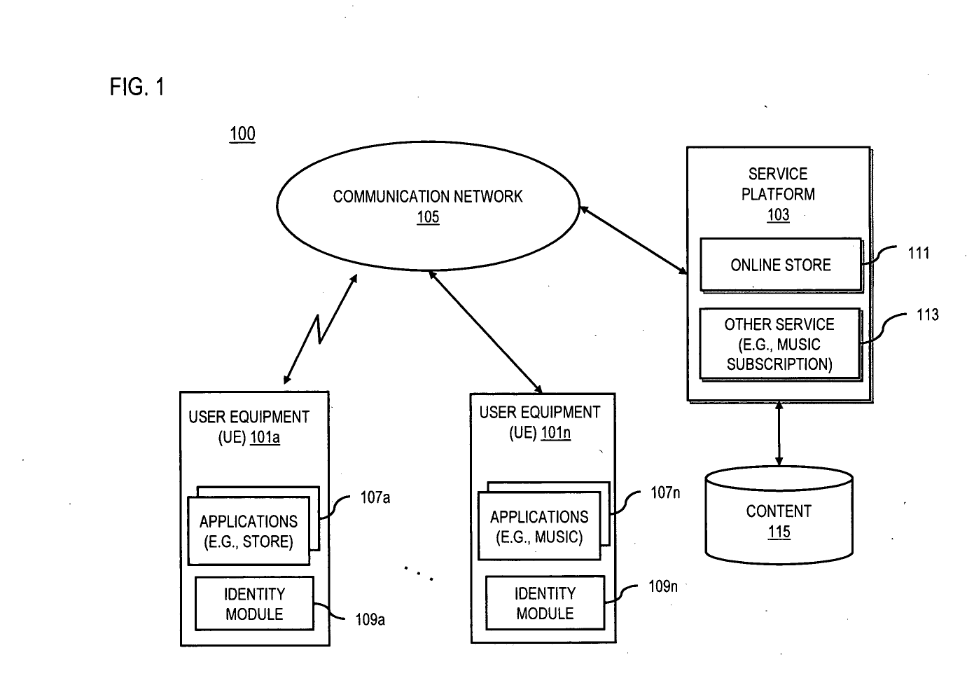

FIG. 1 is a diagram of a system capable of improving the security of a device by clearing user credentials stored on the device, according to one embodiment. In a mobile economy, increasing services and applications can utilize communication networks on devices by storing individual credentials within the devices. However, these devices can be sold, stolen, recycled, or the like without resetting information contained within the device. Thus, another individual may be permitted to access the stored individual credentials on a device that changes possession.

To address this problem, a system 100 of FIG. 1 introduces the capability to detect a change in users and clear the credentials automatically. A user equipment UE 101 can be used by a user to authenticate with a service platform 103 via a communication network 105. The UE 101 may use an application 107, such as an online store application 107a or a music subscription application 107n. A corresponding online store service 111 or music subscription service 113 can be located on the service platform 103. A UE 101 can thus retrieve content 115 from the service platform 103 via applications 107.

According to one embodiment, to facilitate future transactions between the service platform 103 and the application 107, the UE 101 can store credentials used for the authentication within the UE 101. The authentication information can include information such as a user name and password, or a unique identifier. In one embodiment, the UE 101 also has an identity module 109 (e.g., a subscriber identity module (SIM) or a Universal Integrated Circuit Card (UICC)) corresponding to a user or user account. The credentials can be associated with the identity module 109. If the identity module 109 is removed or replaced, the UE 101 can clear the credential information from the UE 101. In this manner, modular identity modules can be used by the user to quickly change devices on the fly. In various embodiments, the application 107 or service platform 103 initiates the deletion of the credential information.

As shown in FIG. 1, the system 100 comprises a one or more UE 101, e.g., UEs 101a-101n, having connectivity to a service platform 103 via a communication network 105. By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), the Internet, or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, mobile ad-hoc network (MANET), and the like.

The UE 101 is any type of mobile terminal, fixed terminal, or portable terminal including a mobile handset, station, unit, device, multimedia tablet, Internet node, communicator, desktop computer, laptop computer, Personal Digital Assistants (PDAs), or any combination thereof. It is also contemplated that the UE 101 can support any type of interface to the user (such as “wearable” circuitry, etc.).

By way of example, the UE 101 and service platform 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

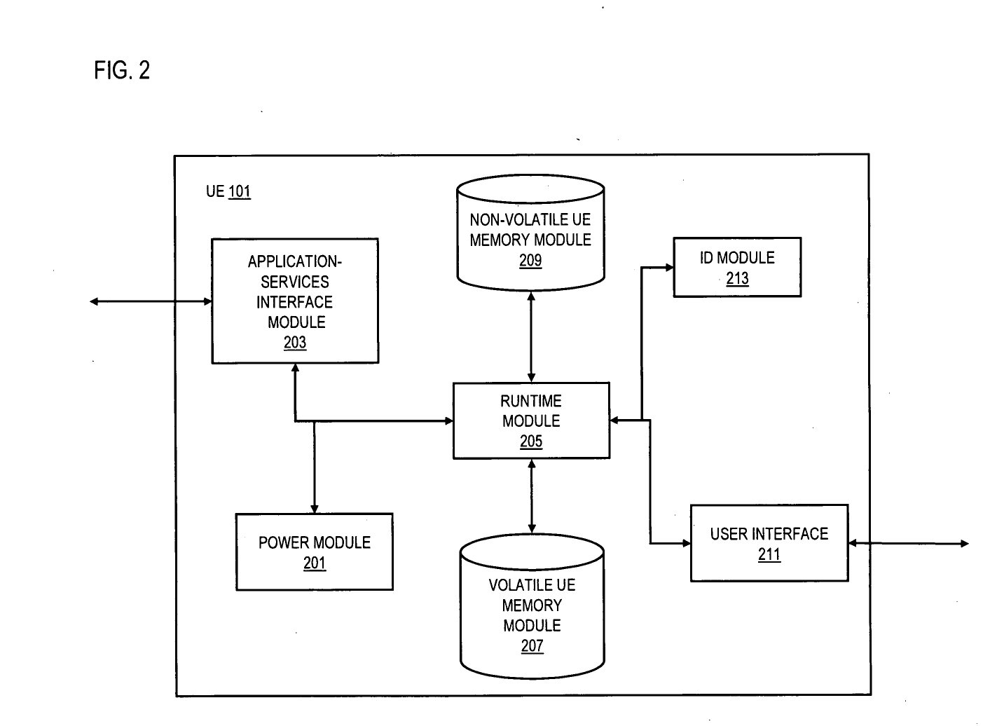

FIG. 2 is a diagram of the components of a UE 101 according to one embodiment. By way of example, the UE 101 includes one or more components for securely running applications and storing user credential information. It is contemplated that the functions of these components may be combined in one or more components or performed by other components of equivalent functionality. In this embodiment, the UE 101 includes a power module 201, an application services interface module 203, a runtime module 205, a volatile memory module 207, a non-volatile memory module 209, a user interface 211, and an identity (ID) module 213.

The power module 201 provides power to the UE 101. The power module 201 can include any type of power source, (e.g., battery, plug-in, etc.). The power module can provide power to the components of the UE 101 including processors, memory, and transmitters.

In one embodiment, the UE 101 includes an application services interface module 203. The application services interface 203 is used by a runtime module 205 to request and receive services from a service platform 103. The application services interface 203 can also be used to authenticate a session between the UE 101 and the service platform 103.

In one embodiment, the UE 101 includes an identity module 213. This identity module 213 can be unique to the user. The identity module 213 can be a SIM card, a UICC, a removable user identity module (R-UIM), or the like. Each of the identity modules may include unique user identifications. For example, a SIM card may have a unique service-subscriber key or International Mobile Subscriber Identity (IMSI) to identify the subscriber or user on mobile UEs 101. This allows a user to change phones by simply removing the SIM card from one UE 101 and inserting the SIM card in another UE 101. The IMSI can be represented by a three digit Mobile Country Code (MCC) followed by a two digit Mobile Network Code (MNC) followed by a ten digit mobile station identification number. A SIM card can also have an Integrated Circuit Card Identification (ICC-ID). The ICC-ID can have a length of up to nineteen or twenty characters. The number can comprise an issuer identification number and an individual account identification.

In one embodiment, the UE 101 includes a runtime module 205 that can process a user's requests via a user interface 211. A user can input a request (e.g., a request to purchase an item) via the user interface 211. The runtime module 205 can then store the request in a volatile UE memory module 207 and process the request. While processing the request, the runtime module 205 can use an application services interface module 203 to authenticate a session with the service platform 103. The authentication can include the user entering credentials (e.g., user name and password data). A user can choose an option to save the credentials onto the UE 101 to facilitate future use of the service. When this option is selected, the service platform 103 or the runtime module 205 can take note of a unique identification number of the ID module 213 and store the information in a memory. When the next authentication takes place, the runtime module 205 or service platform 103 can determine if the ID module 213 has changed. If the ID module 213 has changed, the stored credential information can be reset. A single authentication can be used for multiple services, for example the same user name and password for a store service 111 can also be used to authenticate music subscription services 113. The credentials can be saved in a non-volatile UE memory module 209. The non-volatile UE memory module 209 can also be used to store application executable data as well as other files (e.g., documents, media, etc.).

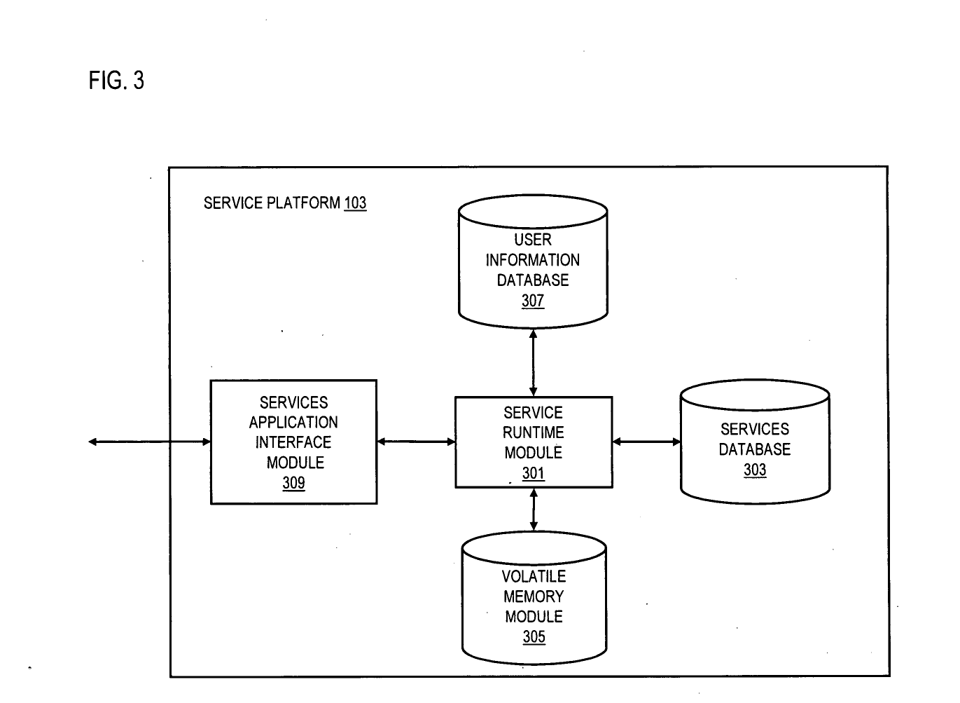

FIG. 3 is a diagram of the components of a service platform 103, according to one embodiment. By way of example, the service platform 103 includes one or more components for securely authenticating and delivering services. It is contemplated that the functions of these components may be combined in one or more components or performed by other components of equivalent functionality. In this embodiment, a service runtime module 301 processes services from a services database 303. The services database 303 can include data regarding online stores, music subscription services, e-mail services, calendar services, contacts services, and the like. The service runtime module 301 can run the services in a volatile memory module 305 and store user information in a user information database 307. The service runtime module 301 can communicate with a user using a UE 101 via a services application interface module 309.

In one embodiment, when providing a service, the service runtime module 301 may request that the UE 101 authenticate before starting a session. During the authentication procedure, the service runtime module 301 can allow the UE 101 to have the option of saving the authentication credentials on the UE 101. When providing this option, the service runtime module 301 can store the required authentication credentials information and an identifier unique to the UE 101 in a user information database. The unique identifier can be from an identity module 213, like a SIM card, of the UE 101. When a user authenticates using stored credentials, the services runtime module 301 can check the user information database 307 to determine if the identity module 213 data has changed. If the identity module 213 data has changed, the services runtime module 301 requests the UE 101 to delete the stored credentials and authenticate manually.

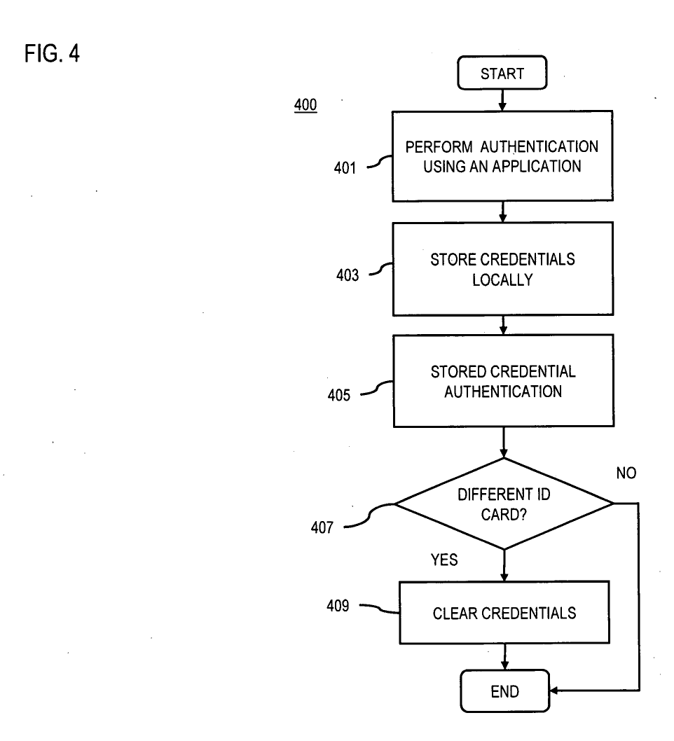

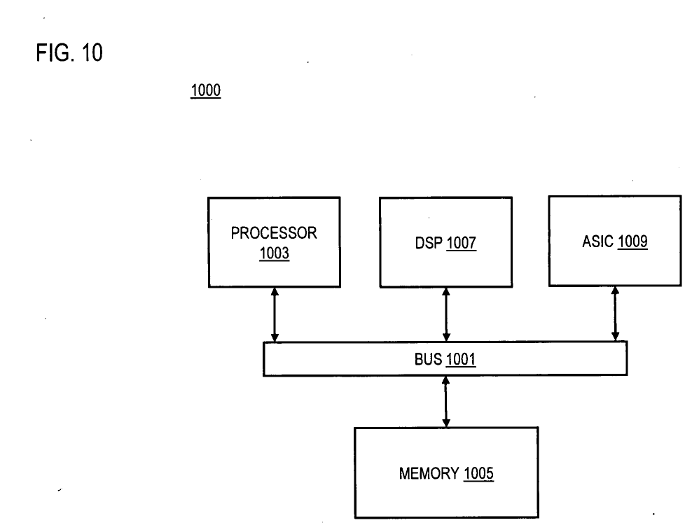

FIG. 4 is a flowchart of a process for clearing the credentials of a UE 101, according to one embodiment. In one embodiment, the service runtime module 301 performs the process 400 and is implemented in, for instance, a chip set including a processor and a memory as shown FIG. 10. A user running an application 107 on a UE 101 can request services from a service platform 103. In step 401, a user authentication is performed by the service runtime module 301 to check the credentials of the user. At step 403, during the authentication process, the user may choose an option to store the credentials locally on the UE 101. The service runtime module 301 can store credential authentication information as well as an identifier associated with the UE 101 in a user information database 307. In some embodiments, the identifier is an identifier associated with an identity module 213. At step 405, the UE 101 can begin another session with the service platform 103 by authenticating using the stored credentials. In one embodiment, the service runtime module 301 also requests the identifier associated with the identity module 213 during the authentication process. At step 407, the service runtime module 301 determines if the identity module 213 has changed. If the identity module 213 has changed, the UE 101 is instructed to delete the credentials stored on the UE 101. At step 409, the credentials stored on the UE 101 are cleared. In one embodiment, an application (e.g., a purchasing application) executed on the runtime module 301 deletes the credentials stored on the UE 101.

With the above approach, users can securely and conveniently store user credentials onto a UE 101. In this manner, a service platform 103 can determine if the user using the UE 101 has changed. For example, this approach will allow a service platform 103 detect if an identity module 213 has been changed and clear the user credential information based on a detected change. This can save unnecessary use of network resources, e.g., bandwidth, in attempting to conduct a transaction with an invalid set of credentials.

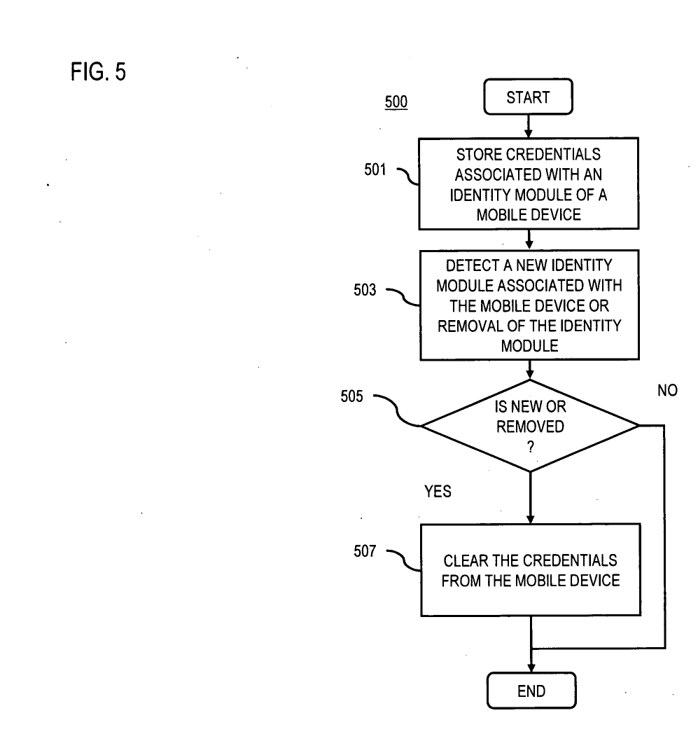

FIG. 5 is a flowchart of a process for client-side clearing of credentials of a UE 101, according to one embodiment. In one embodiment, the UE 101 can be a mobile device. In this embodiment, the UE 101 runtime module 205 performs the process 500 and is implemented in, for instance, a chip set including a processor and memory as shown in FIG. 10. A user authenticates into a user session for access to services provided by a service platform 103. During the authentication process, the user requests that the credentials used to authenticate are automatically inputted to the system without user invention. A user can request this option by selecting a “remember me” option; that is, this capability permits the user to specify a desire to store information pertaining to the user for expediently conducting future transactions. The credentials may be associated with user via an identifier of a removable identity module 213. In this approach, the removable identity module 213 may contain an identifier, such as an IMSI, that can be associated with the credentials.

In step 501, the credentials and the associated identifier are stored within a non-volatile memory of the UE 101 the user is using. The credentials can be saved in a username and password digest, or as a separate file containing the credentials. When the UE 101 needs to re-authenticate, the UE 101 runtime module 205 retrieves the credentials as well as the associated identifier. The runtime module 205 then retrieves the corresponding identifier from the identity module 213. If the identity module 213 is changed or removed, the corresponding identifier is different from the associated identifier.

At step 503, the runtime module 205 detects if the identity module 213 has been removed, replaced, or changed. An identity module 213 may be replaced by an individual because the UE 101 has been lost and found by another, recycled, sold, or stolen. At step 505, if the identifier from the identity module 213 matches the associated identifier, the runtime module performs the re-authentication process. If the associated identifier does not match the identifier from the identity module 213, at step 507, the runtime module 205 clears the credentials from the UE 101. The credentials can be cleared by deleting the file the user credentials were saved at or by removing the credentials from a user name and password digest. Alternatively, a user may choose to and select an option to delete the user credentials from a UE 101.

With the above approach, users can securely store and automatically remove user credentials onto a UE 101. In this approach, an application runtime module 205 can determine if a user identity module 213 has been changed or removed. The application module can thus detect the security issue and clear the user credentials.

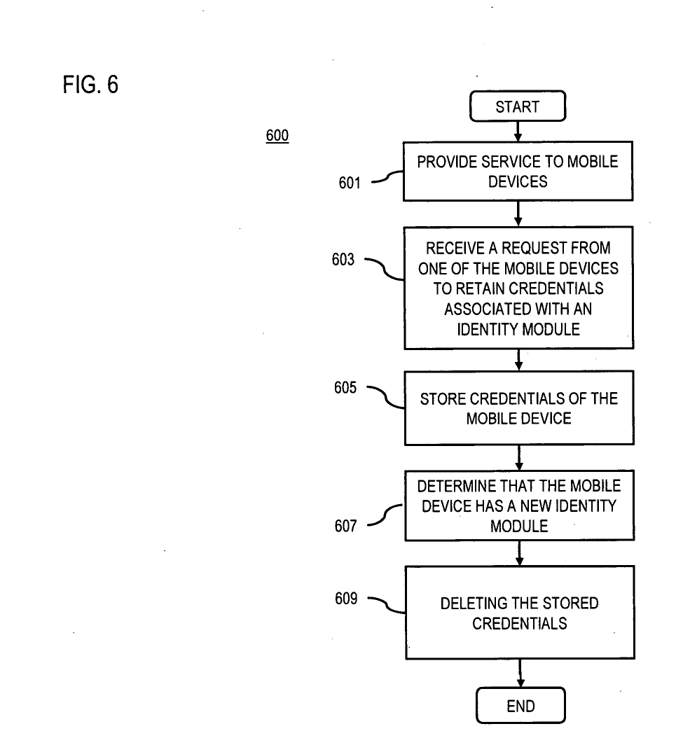

FIG. 6 is a flowchart of a process for server-side clearing of credentials of a UE 101, according to one embodiment. In one embodiment, the service platform 103 performs the process 600 and is implemented in, for instance, a chip set including a processor and a memory as shown FIG. 10. At step 601, a service platform 103 provides services for multiple UEs 101 (e.g., mobile devices). A user using a UE 101 requests services from the service platform 103 that require authentication. The UE 101 can then authenticate using credentials. The authentication information may include the inputted credentials as well as an identifier associated with an identity module 213 disposed upon the UE 101. While authenticating, the user selects an option to save the inputted credentials for facilitating future authentication. At step 603, the service platform 103 receives a request from the UE 101 to retain the credentials on the UE 101. At step 605, the service platform 103 stores the credentials as well as the associated identifier in a credentials digest to use for later authentication. The UE 101 may then store the credentials in a memory.

A user can then authenticate using the credentials stored on the UE 101. During the authentication process, the UE 101 sends the stored credentials as well as a current identifier from an identity module 213 associated with the UE 101. The service platform 103 receives the credentials and the current identifier and compares the credentials and current identifier to the credentials digest. If the credentials digest finds that the current identifier does not match the associated identifier, the identity module 213 is new or has been changed. This can indicate that the user that saved the authenticated information has changed. At step 607, the service platform determines that the UE 101 has a new identity module 213 based on the credential comparison. At step 609, the service platform rejects authentication and requests that the UE 101 delete the stored credentials. The UE 101 then deletes the stored credentials and is requested to re-authenticate manually.

With the above approach, a service provider can securely store and remove user credentials on a UE 101. In this manner, a service provider can determine if the user using the UE 101 has changed by detecting a change in an identity module. Thus a service user can feel secure that the user's credential information will not be compromised because the UE 101 is stolen, sold, or otherwise lost.

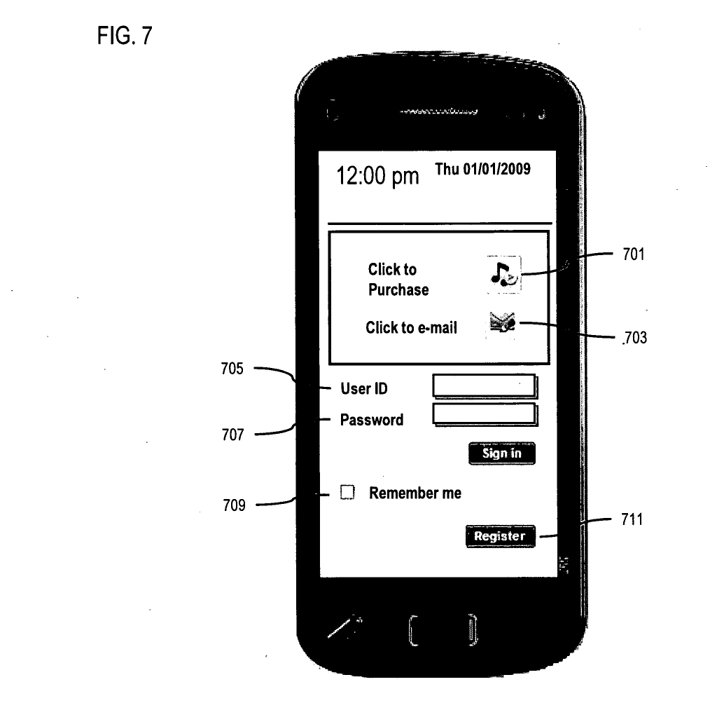

FIG. 7 is a diagram of a user interface utilized in the processes of FIG. 4 to FIG. 6, according to one embodiment. The interface 700 displays an option screen for using services provided by a service platform 103. The display allows a user to purchase music 701 or utilize e-mail 703. The user can login using a User ID 705 and password 707 as credentials. The user may select a “remember me” box 709 to store the credential information on the user's local UE 101. If the user does not have an account, the user can register 711 with the service provider. During the registration process, a set of credentials can be created (e.g., username and password) and associated with user information (e.g., contact information, credit card information, etc.). The user may use a touch-screen interface, a keypad (not shown), a scroll and click input (not shown), or other input means to enter commands into the user interface 700. A single service provider can provide multiple services using a single authentication (e.g., store purchasing services and e-mail).

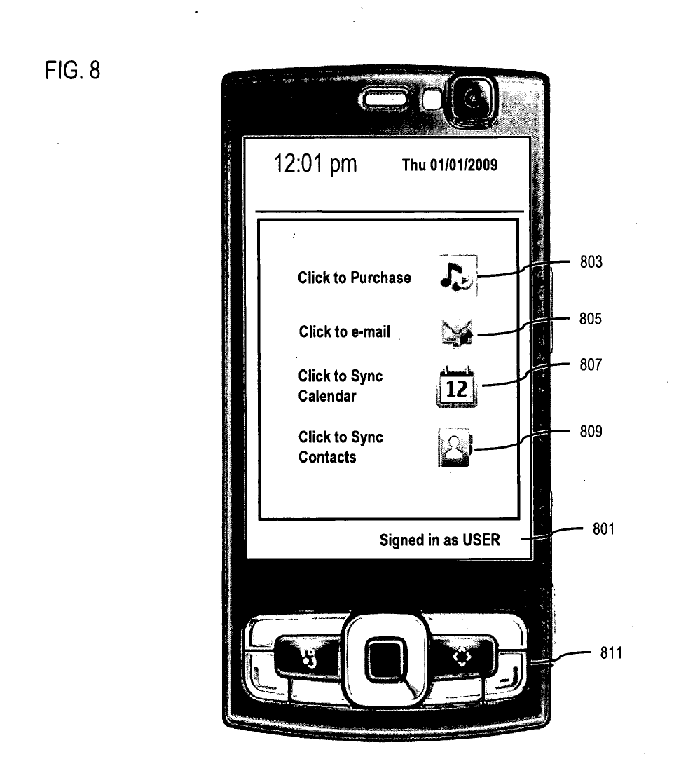

FIG. 8 is a diagram of a user interface utilized in the processes of FIG. 4 to FIG. 6, according to one embodiment. The interface 800 displays an option screen of a signed-in user 801. The user is provided options to access services that are available on the account that the user has signed into. For example, the user may be able to access a store 803, e-mail 805, a personalized calendar 807, or a personalized contacts list 809. The user may use a move and click input 811, a keypad, (not shown), a touch-screen interface, or other means to input data into the user interface 800. Utilizing this interface, the user is signed into a user account securely by storing account credentials on the UE 101 and can consume services without repeatedly authenticating when a session is closed. If a new user accesses the UE 101, the credentials are cleared from the UE 101.

The processes described herein for providing user credential security may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

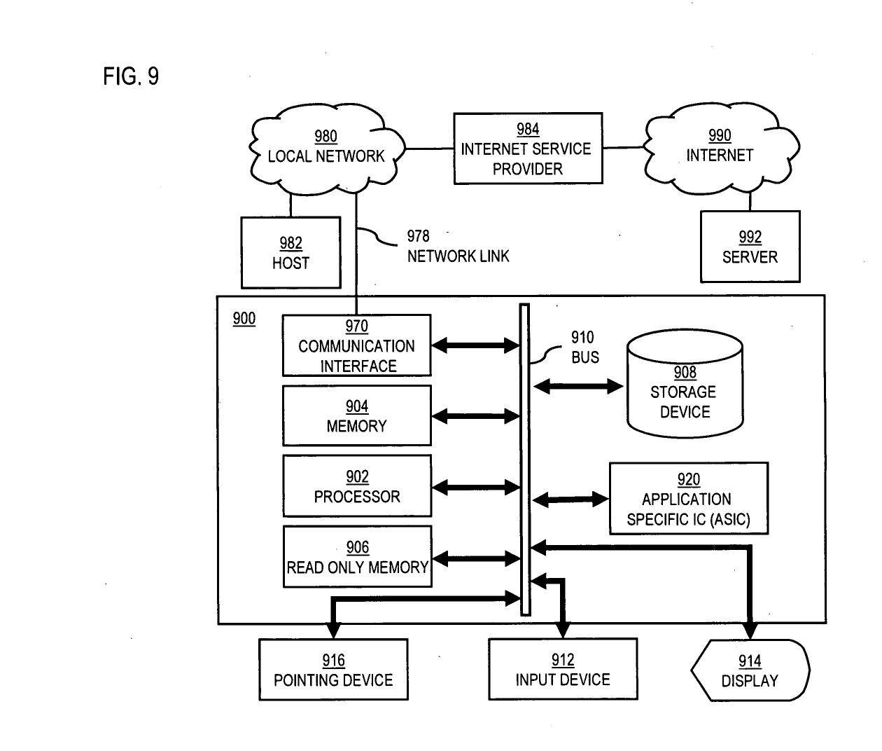

FIG. 9 illustrates a computer system 900 upon which an embodiment of the invention may be implemented. Computer system 900 is programmed (e.g., via computer program code or instructions) to securely clear credentials as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 910 includes one or more parallel conductors of information so that information is transferred quickly among devices coupled to the bus 910. One or more processors 902 for processing information are coupled with the bus 910.

A processor 902 performs a set of operations on information as specified by computer program code related to securely clearing credentials. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or other dynamic storage device, stores information including processor instructions for securely clearing credentials. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for securely clearing credentials, is provided to the bus 910 for use by the processor from an external input device 912, such as a keyboard containing alphanumeric keys operated by a human user, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT) or a liquid crystal display (LCD), or plasma screen or printer for presenting text or images, and a pointing device 916, such as a mouse or a trackball or cursor direction keys, or motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of application specific ICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 105 for providing services to the UE 101.

The term computer-readable medium is used herein to refer to any medium that participates in providing information to processor 902, including instructions for execution. Such a medium may take many forms, including, but not limited to, non-volatile media, volatile media and transmission media. Non-volatile media include, for example, optical or magnetic disks, such as storage device 908. Volatile media include, for example, dynamic memory 904. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

FIG. 10 illustrates a chip set 1000 upon which an embodiment of the invention may be implemented. Chip set 1000 is programmed to securely clear credentials as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to securely clear credentials based on a user change. The memory 1005 also stores the data associated with or generated by the execution of the inventive steps.

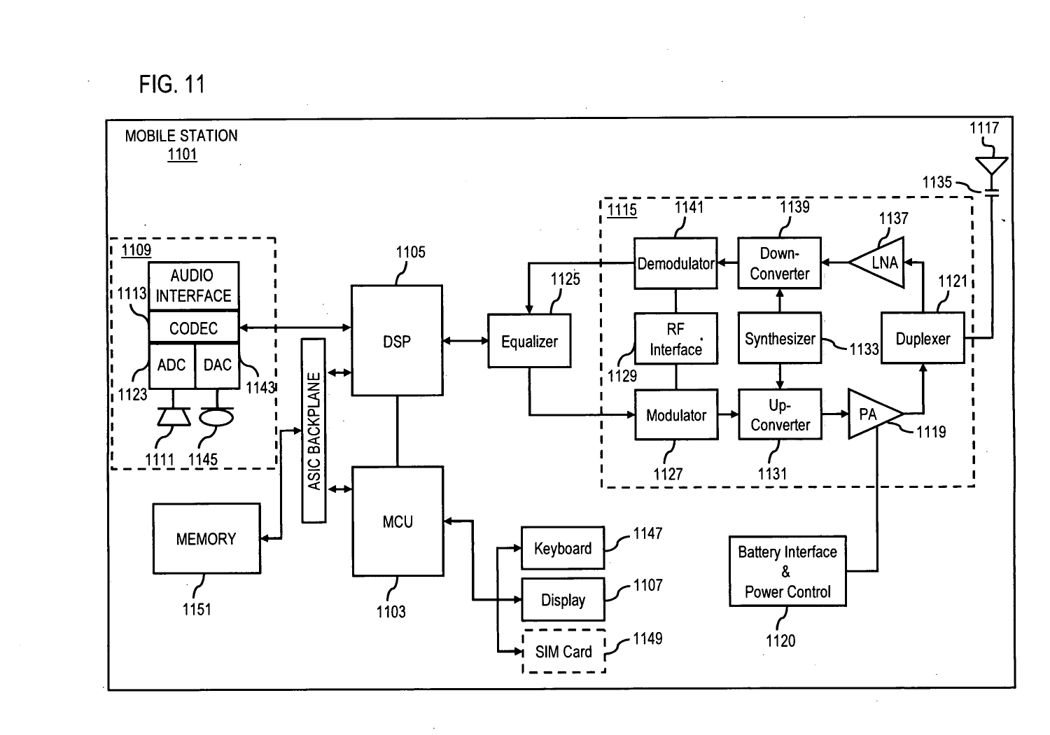

FIG. 11 is a diagram of exemplary components of a mobile station (e.g., handset) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile station functions that offer automatic contact matching. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile station 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103-which can be implemented as a Central Processing Unit (CPU) (not shown).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile station 1101 to securely clear credentials and use services. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the station. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile station 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile station 1101 on a radio network. The card 1149 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
storing credentials associated with an identity module of a mobile device;
detecting a new identity module associated with the mobile device or removal of the identity module; and
clearing the credentials from the mobile device based on the detection.

2. A method of claim 1, wherein credentials comprise username and password.

3. A method of claim 1, wherein the determining step is performed by an application residing on the mobile device.

4. A method of claim 3, wherein the application is a purchasing application.

5. A method of claim 1, wherein the new identity module is a subscriber identity module (SIM).

6. A method of claim 1, further comprising:
receiving a user input to clear the credentials.

7. A method of claim 1, further comprising:
initiating login on an online store enabling purchase of content; and
generating a request specifying storage of the credentials by the online store.

8. An apparatus comprising:
at least one processor; and
at least one memory including computer program code,
the at least one memory and the computer program code configured to, with the at least one processor, cause the apparatus to perform at least the following,
store credentials associated with an identity module of a mobile device,
detect a new identity module associated with the mobile device or removal of the identity module, and
clear the credentials from the mobile device based on the detection.

9. An apparatus of claim 8, wherein credentials comprise username and password.

10. An apparatus of claim 8, wherein the new identity module is a subscriber identity module (SIM).

11. An apparatus of claim 8, wherein the apparatus is further caused to receive a user input to clear the credentials.

12. A apparatus of claim 8, wherein the apparatus is further caused to:
initiate login on an online store enabling purchase of content; and
generate a request specifying storage of the credentials by the online store.

13. A method comprising:
providing a service to a plurality of mobile devices;
receiving a request from one of the mobile devices to retain credentials associated with an identity module of the one mobile device;
storing the credentials of the one mobile device;
determining that the one mobile device has a new identity module associated with the one mobile device; and
deleting the stored credentials based on the determination.

14. A method of claim 13, wherein credentials comprise username and password.

15. A method of claim 13, wherein the new identity module is a subscriber identity module (SIM).

16. A method of claim 13, wherein the service is an online store.

17. An apparatus comprising:
at least one processor; and
at least one memory including computer program code,
the at least one memory and the computer program code configured to, with the at least one processor, cause the apparatus to perform at least the following,
provide a service to a plurality of mobile devices,
receive a request from one of the mobile devices to retain credentials associated with an identity module of the one mobile device,
store the credentials of the one mobile device,
determine that the one mobile device has a new identity module associated with the one mobile device, and
delete the stored credentials based on the determination.

18. An apparatus of claim 17, wherein credentials comprise username and password.

19. An apparatus of claim 17, wherein the new identity module is a subscriber identity module (SIM).

20. An apparatus of claim 17, wherein the service is an online store.
